(19) United States
(12) Patent Application Publication
(10) Pub. No.: US 2025/0199541 A1
(43) Pub. Date: Jun. 19, 2025

(54) UNMANNED MOVING OBJECT, INFORMATION PROCESSING METHOD, AND COMPUTER PROGRAM

(71) Applicant: Sony Group Corporation, Tokyo (JP)

(72) Inventors: Tadashi SASAKI, Tokyo (JP); Kazuki ATSUTA, Tokyo (JP)

(73) Assignee: Sony Group Corporation, Tokyo (JP)

(21) Appl. No.: 18/849,543

(22) PCT Filed: Mar. 14, 2023
(86) PCT No.: PCT/JP2023/009837

§ 371 Date: Sep. 23, 2024

(30) Foreign Application Priority Data
Mar. 31, 2022 (JP) 2022-060789

(51) Int. Cl. G05D 1/633; G05D 1/222; G05D 103/00; G05D 109/20; G05D 111/10; G05D 111/20; G05D 111/30

(52) U.S. Cl. CPC G05D 1/633; G05D 1/222; G05D 2103/00; G05D 2109/20; G05D 2111/10; G05D 2111/20; G05D 2111/30

(57) ABSTRACT

A drone which is an unmanned moving object according to an embodiment includes a flight controller that controls the driving of the drone, a first communication unit that communicates with an operation device that remotely controls the drone, and a second communication unit that receives unique information sent out from another moving object for identifying presence and/or a position of the other moving object.

### TECHNICAL FIELD

The present disclosure relates to an unmanned moving object, an information processing method, and a computer program.

### BACKGROUND ART

A drone, which is an example of an unmanned moving object, is used for various purposes such as aerial photography, measurement, disaster relief, and transport logistics. Note that in a case of being simply referred to as a drone, this term means an unmanned flying object.

Some drones include a means for detecting another drone present around the drone. Examples of an approach for detecting another drone include the time of flight (TOF) for detecting the position of another drone with an infrared sensor provided in the drone, and detecting another drone with a camera provided in the drone.

However, in a case of using an infrared sensor, another drone present at a position relatively distant from the drone may not be precisely detected. Infrared sensors can detect another drone in a short distance of about 10 m with high accuracy, but the reliability for detection may decrease when the distance reaches, for example, about 30 m.

Furthermore, in the TOF, infrared light is sent out with predetermined directivity. Consequently, in a case of enabling the detection of another drone in all directions, the number and the occupied range of the infrared sensors increase. This may lead to restrictions on installation of other components and an increase in weight.

On the other hand, in a case of detecting another drone with a camera, the distance of the other drone cannot be accurately detected. Specifically, drones come in various sizes, so that the distance of the other drone cannot be accurately detected using only an image signal. Furthermore, cameras have an angle of view. Consequently, also in a case where the detection in all directions is performed with the camera, the issue of an increase in the number and the occupied range thereof may occur similarly to the TOF. Note that stereo cameras can measure the distance to an object around them. However, stereo cameras also have an angle of view and are relatively larger, so that the issue of an increase in the number and the occupied range thereof may occur.

Demand for drones is expected to expand in the future. Then, a situation where many drones fly in midair can be realized. In the situation where many drones fly, many accidents may occur. Thus, it is essential to ensure safety during flight. According to this viewpoint, it is important to precisely detect another drone. Furthermore, in a case of analyzing an accident, it is also important to precisely detect and identify, for example, the position, the flight status, and the like of another drone afterwards.

### CITATION LIST

### Patent Document

Patent Document 1: WO 2020/116496 A

### SUMMARY OF THE INVENTION

### Problems to be Solved by the Invention

The present disclosure has been made in view of the above-described circumstances, and provides an unmanned moving object, an information processing method, and a computer program capable of detecting another moving object with high reliability.

### Solutions to Problems

An unmanned moving object of the present disclosure includes a drive control unit that controls driving of the unmanned moving object, a communication unit that communicates with an operation device that remotely controls the unmanned moving object, and an other-device information reception unit that receives unique information sent out from another moving object for identifying presence and/or a position of the other moving object.

An information processing method of the present disclosure performed in an unmanned moving object, the information processing method includes a step of receiving unique information sent out from another moving object for identifying presence and/or a position of the other moving object.

A computer program of the present disclosure for executing information processing in an unmanned moving object, the computer program causes a computer to execute a step of receiving unique information sent out from another moving object for identifying presence and/or a position of the other moving object.

### BRIEF DESCRIPTION OF DRAWINGS

FIG. 1 is a diagram illustrating a situation where a drone as an unmanned moving object according to an embodiment is caused to fly with an operation device.

FIG. 2 is a block diagram illustrating a configuration of the drone according to the embodiment.

FIG. 3 is a block diagram illustrating a detailed configuration of a communication module in the drone according to the embodiment.

FIG. 4 is a block diagram illustrating a configuration of other-device drones as other moving objects illustrated in FIG. 1.

FIG. 5 is a flowchart illustrating an example of processing performed in the drone according to the embodiment.

FIG. 6 is a diagram illustrating an example of operation of the drone controlled using the processing illustrated in FIG. 5.

FIG. 7 is a diagram illustrating another example of operation of the drone controlled using the processing illustrated in FIG. 5.

FIG. 8 is a block diagram illustrating a configuration of a communication module according to a modification.

FIG. 9 is a block diagram illustrating a configuration of a communication module according to another modification.

FIG. 10 is a block diagram illustrating a configuration of a communication module according to still another modification.

FIG. 11 is a block diagram illustrating a configuration of a communication module according to still another modification.

FIG. 12 is a diagram illustrating an example of a hardware configuration of an information processing apparatus that may constitute the drone according to the embodiment.

### MODE FOR CARRYING OUT THE INVENTION

Hereinafter, an embodiment of the present disclosure will be described with reference to the drawings.

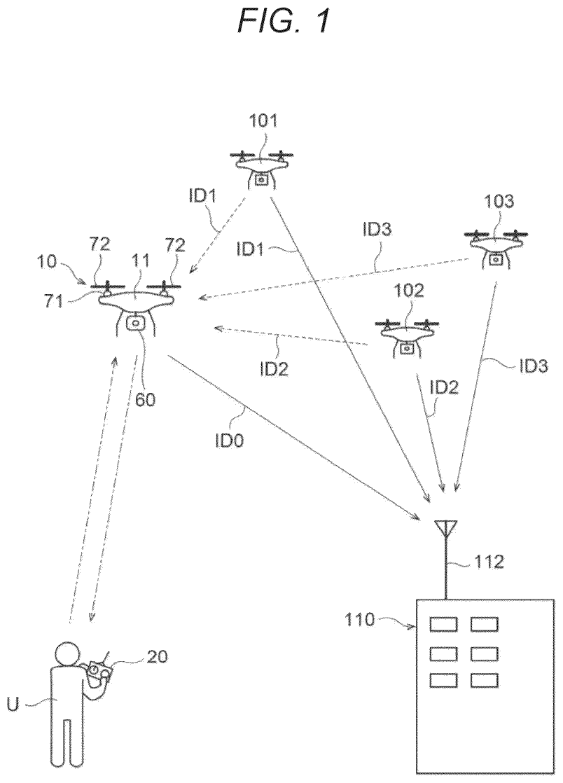

FIG. 1 illustrates a situation where a drone 10 as an unmanned moving object according to an embodiment is caused to fly with an operation device 20. The drone 10 flies by being remotely controlled by the operation device 20. Note that in a case of being simply referred to as a drone, this term means an unmanned flying object.

### <Overview of Usage Environments and Functions of Drone>

First, an overview of usage environments of the drone 10 and functions of the drone 10 according to the present embodiment will be described with reference to FIG. 1. The drone 10 and the operation device 20 can perform bidirectional wireless communication. In FIG. 1, manual operation is performed in which an operator U controls the drone 10 via the operation device 20. In this case, the drone 10 receives a control command based on a user's intention transmitted from the operation device 20 and is controlled on the basis of the control command, for example. The control command is a control command based on a user's intention, such as moving forward, moving backward, turning left, turning right, ascending, and descending. The control command is generated by the operator U directly operating the operation device 20. Meanwhile, the drone 10 may transmit, for example, information on the current position and the captured image to the operation device 20.

In addition to the above example, the control command may include a command related to movement to a target position relatively or absolutely determined with respect to the drone 10. The control command may also include a command related to a state change to a target velocity, a target angular velocity during turning, or a target posture, and the like.

Furthermore, the drone 10 is also capable of autonomously flight (autonomous movement). Specifically, after a route is designated from the operation device 20, the drone 10 can autonomously move along the designated route. In addition, the drone 10 can generate a route to a predetermined return position by itself, and autonomously return along the generated route. Such autonomous return processing may be referred to as return to home (hereinafter, “RTH”).

In addition, the drone 10 is also capable of semi-autonomous flight. The semi-autonomous flight mentioned herein refers to an operation state in which the autonomous flight is temporarily performed during manual flight through the manual operation. For example, the drone 10 during the manual flight may lose communication with the operation device 20, or may move out of the user's field of view due to going behind structures or the like. In such a case, the drone 10 may temporarily shift to the RTH and perform the semi-autonomous flight, for example.

The manual flight, the autonomous flight, and the semi-autonomous flight of the drone 10 as described above may be performed within the field of view of the operator U or may be performed outside the field of view of the operator U. In a case where the manual flight is performed outside the field of view, a means capable of recognizing the current position of the drone 10 is necessary. Such a means may include, for example, display of the current position of the drone 10 or display of an image being captured by the drone 10 provided on the operation device 20.

The operation device 20 in the present embodiment is an operation-dedicated device gripped by the operator U and including an antenna that transmits the control command. Note that the operation device 20 may be, for example, a smartphone, a tablet, a personal computer, or the like.

For example, in a case where the operation device 20 is implemented by a smartphone or a tablet, the operation device 20 may directly transmit the control command according to a communication method such as Bluetooth (registered trademark). Alternatively, the control command may be transmitted to the drone 10 according to a communication method such as Wi-Fi via a router, or a router and a base station.

FIG. 1 illustrates other-device drones 101 to 103 as other moving objects. These other-device drones 101 to 103 are operated by other operators or are autonomously operated.

FIG. 1 also illustrates a flying object monitoring facility 110. The flying object monitoring facility 110 is a facility for monitoring objects that are flying including unmanned flying objects. The flying object monitoring facility 110 may be a facility installed by countries or local governments for the security of flying objects. The flying object monitoring facility 110 includes an antenna 112. The antenna 112 receives information from a moving object that is flying, and the received information is used to identify the position of the flying object. The flying object monitoring facility 110 may further include a sonar or a camera (not illustrated), thereby further monitoring flying objects.

In the situation illustrated in FIG. 1, the drone 10 and the other-device drones 101 to 103 according to the present embodiment each transmit, to the flying object monitoring facility 110, unique information ID0 to ID3, respectively, for causing the flying object monitoring facility 110 to identify its own presence and/or position, as indicated by solid line arrows in the drawing. The flying object monitoring facility 110 uses the unique information ID0 to ID3 to detect the presence and/or position of each of the drone 10 and the other-device drones 101 to 103.

In the present embodiment, pieces of the unique information ID0 to ID3 each include, as an example, information of the aircraft registration number, information of the aircraft manufacturing number, information of the current position, and information of the current time.

Specifically, the aircraft registration number in the present embodiment is, for example, a number set by others such as countries or local governments for an unmanned flying object such as the drone 10 and the other-device drones 101 to 103. Such an aircraft registration number is a number issued by countries or local governments in response to an application of request for flying an unmanned flying object or an application for possession of an unmanned flying object. In addition, the aircraft manufacturing number may be a number assigned by a manufacturer who manufactured the unmanned flying object.

In addition, the information of the current position described above is information on the current position of an unmanned flying object detected by the unmanned flying object itself, and is information on the position of the unmanned flying object when the unmanned flying object transmits the unique information. Unmanned flying objects intended for transmitting the unique information can typically detect the position of itself by combining a global navigation satellite system (GNSS), the time of flight (TOF), a barometric pressure sensor, a geomagnetic sensor, and the like. In addition, the information of the current time described above is information on the time when the unmanned flying object transmits the unique information. Unmanned flying objects typically have a clock function. Alternatively, the time information may also be extracted from a signal from a satellite received with the GNSS.

Specifically, the unique information ID0 to ID3 in the present embodiment is information that is mandated to be sent out from the unmanned flying object when flying (moving) the unmanned flying object by the remote ID system. In the remote ID system, sending out the aircraft registration number, the aircraft manufacturing number, the position information, the time, and authentication information from the unmanned moving object to the aviation authorities, the police, and the important facility administrators is listed.

Note that the remote ID system is established by, for example, the Ministry of Land, Infrastructure, Transport and Tourism of Japan, the Federal Aviation Administration of the United States of America, and the European Union Aviation Safety Agency of the European Union. The unique information may be information designated by the remote ID system in foreign countries or a system equivalent thereto.

Then, under the usage environment as described above, the drone 10 according to the present embodiment includes a function of receiving, from the other-device drones 101 to 103, the pieces of the unique information ID1 to ID3 sent out therefrom, as indicated by broken line arrows in FIG. 1. Then, the drone 10 receives the pieces of the unique information ID1 to ID3 as information for identifying the presence and/or the position of the other moving objects, and in the present embodiment, records the received pieces of the unique information ID1 to ID3. In addition, the drone 10 uses the received pieces of the unique information ID1 to ID3 for detecting the presence and/or the position of the other moving objects.

### <Configuration of Drone>

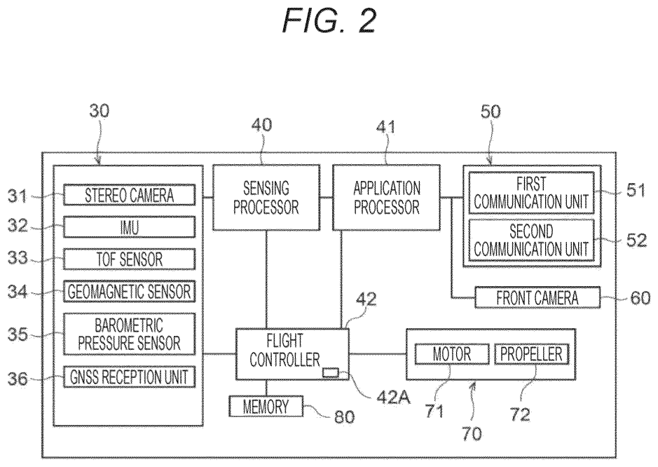

FIG. 2 is a block diagram illustrating a configuration of the drone 10. Hereinafter, a configuration and a function of the drone 10 will be described in detail. The drone 10 includes a sensor module 30, a sensing processor 40, an application processor 41, a flight controller 42, a communication module 50, a front camera 60, a drive module 70, and a memory 80.

The sensor module 30 includes a stereo camera 31, an inertial measurement unit (IMU) 32, a TOF sensor 33, a geomagnetic sensor 34, a barometric pressure sensor 35, and a GNSS reception unit 36. The sensor module 30 or a part or all of the sensors included in the sensor module 30 corresponds to a detection unit that detects obstacles present around the unmanned moving object. The obstacles refer to potential obstacles to the flight of the drone 10, including such as flying objects other than the drone 10, buildings, trees, people, vehicles, ground surfaces, mountain surfaces, and water surfaces.

The stereo camera 31 images the periphery of the drone 10 with two or more imaging units, and acquires two or more image signals different from each other. The two or more image signals are used to detect the distance from the drone 10 to the object on the captured image. That is, the stereo camera 31 functions as a ranging sensor. The two or more image signals acquired by the stereo camera 31 are provided to the sensing processor 40, and the distance from the drone 10 to the object on the captured image is detected through calculation by the sensing processor 40. Note that in addition to the stereo camera 31 or instead of the stereo camera 31, any one of, or a combination of two types or more of a millimeter-wave ranging sensor such as a radar, an optical ranging sensor such as a TOF sensor and the Light Detection and Ranging (LiDAR), and an ultrasonic ranging sensor may be used as the ranging sensor. Alternatively, instead of the stereo camera 31, a monocular camera may be used, and an obstacle may be detected through image analysis.

The stereo camera 31 may include a plurality of units including two or more imaging units. For example, the stereo camera 31 may include the five above-described units, and the five units may be directed in five directions of front, rear, left, right, and downward. However, a configuration of the stereo camera 31 is not particularly limited to such a configuration. For example, the stereo camera 31 may include only the one above-described unit facing to the front, or may include only the two above-described units for the left and the right.

The IMU 32 includes, for example, a three-axis gyro sensor and a three-direction acceleration sensor, and measures the angular velocity and the acceleration of the drone 10. The information of the angular velocity and the acceleration of the drone 10 measured by the IMU 32 is provided to the sensing processor 40 and the flight controller 42. Note that two IMUs may be provided to provide the measured information to the sensing processor 40 by one of the IMUs and provide the measured information to the flight controller 42 by the other of the IMUs.

The TOF sensor 33 measures the distance to an object, the ground surface, or the like around the drone 10 with the time from when the light is emitted until the reflected light returns. The light emitted from the TOF sensor 33 may be infrared light. The TOF sensor 33 provides the information of the distance to an object or the ground around the drone 10 to the flight controller 42.

The geomagnetic sensor 34 measures the orientation of the drone 10 through measurement of the geomagnetism. The geomagnetic sensor 34 provides the information on the orientation of the drone 10 to the flight controller 42.

The barometric pressure sensor 35 measures the barometric pressure. The barometric pressure sensor 35 provides the information of the barometric pressure to the flight controller 42. The barometric pressure varies depending on the height from the ground surface. Thus, the altitude of the drone 10 can be calculated on the basis of the barometric pressure measured by the barometric pressure sensor 35.

The GNSS reception unit 36 receives a signal from a GPS satellite or another satellite (for example, Galileo or QZSS), and detects the current position of the drone 10 on the basis of the received signal. In addition, the GNSS reception unit 36 receives the time information from the GPS satellite or the other satellite. The GNSS reception unit 36 provides the information of the current position of the drone 10 and the time information to the flight controller 42.

The sensing processor 40 detects an object around the drone 10 and/or the distance to the object on the basis of the information from the sensor module 30. As described above, two or more image signals acquired by the stereo camera 31 are provided to the sensing processor 40. The sensing processor 40 detects the distance from the drone 10 to the object on the captured image through calculation. Furthermore, by considering the information from the IMU 32 at this time, it is possible to improve the accuracy of detecting an object around the drone 10 and/or the distance to the object. The sensing processor 40 provides the detected information of the object around the drone 10 and/or the distance to the object to the flight controller 42. The flight controller 42 can control the flight state (driving) of the drone 10 on the basis of the information from the sensing processor 40.

The application processor 41 mainly performs data processing inside the drone 10 and data processing between the drone 10 and the outside. For example, the application processor 41 instructs the communication module 50 to transmit information to the operation device 20, and performs processing of providing the information received by the communication module 50 to the flight controller 42. In addition, the application processor 41 controls the front camera 60.

The flight controller 42 controls the driving of the drone 10 and corresponds to a drive control unit that controls the driving of an unmanned moving object. The flight controller 42 receives the control command transmitted from the operation device 20 and controls the driving of the drone 10 on the basis of the control command, for example. Specifically, the flight controller 42 controls the driving of the drive module 70 on the basis of the control command to operate the drone 10 in a desired state.

In a case where a route is designated from the operation device 20, the flight controller 42 controls the driving of the drone 10 so that the drone 10 autonomously flies along the route. Furthermore, in a case of, for example, the autonomous flight with the RTH, the flight controller 42 itself generates the route. Then, the flight controller 42 controls the driving of the drone 10 so that the drone 10 flies along the generated route. In a case of the autonomous flight along the route, the flight controller 42 detects the current position and surrounding obstacles on the basis of the information from the sensor module 30 to enable appropriate change of the designated route or the initially generated route.

Furthermore, the flight controller 42 according to the present embodiment can control the driving of the drone 10 to avoid danger, for example, on the basis of any one of, or a combination of two or more of pieces of the information from the sensor module 30, the information from the sensing processor 40, and the information from the application processor 41.

Specifically, for example, when an object in proximity to the drone 10 is detected by the TOF sensor 33 in the sensor module 30, the flight controller 42 can control the driving of the drone 10 so as to move the drone 10 away from the object. In addition, for example, when an object in proximity to the drone 10 is detected by the sensing processor 40 on the basis of the image signals from the stereo camera 31, the flight controller 42 can control the driving of the drone 10 so as to move the drone 10 away from the object.

Furthermore, as described above, the drone 10 has a function of receiving, from the other-device drones 101 to 103, the pieces of the unique information ID1 to ID3 sent out therefrom. The pieces of the unique information ID1 to ID3 are received from the communication module 50 and sent to the flight controller 42 via the application processor 41. Then, the flight controller 42 can further control the driving of the drone 10 on the basis of these pieces of the unique information ID1 to ID3.

The flight controller 42 according to the present embodiment includes, as a part of the functional portion thereof, an analysis unit 42A that analyzes the pieces of the unique information ID1 to ID3. The analysis unit 42A identifies whether or not the pieces of the unique information ID1 to ID3 have been sent out from other unmanned flying objects (other moving objects) and pieces of the position information of the other unmanned flying objects. The analysis is performed by detecting pieces of the information of the aircraft registration number, pieces of the information of the aircraft manufacturing number, pieces of the information of the current position, and pieces of the information of the current time of the other unmanned flying objects through demodulation of the pieces of the unique information ID1 to ID3, and appropriately comparing them with pieces of the information of the drone 10 which is the own device. Whether or not the pieces of the unique information ID1 to ID3 have been sent out from other moving objects is determined through comparison with the aircraft registration number or the aircraft manufacturing number of the own device held by the drone 10. In addition, the analysis unit 42A may further identify a period in which the unique information is sent out from the other unmanned flying object.

Then, the flight controller 42 can identify at least one of the relative positions (for example, X, Y, Z), and the distances and directions of the other-device drones 101 to 103 with respect to the drone 10 on the basis of the information based on the pieces of the unique information ID1 to ID3 identified by the analysis unit 42A. Furthermore, the flight controller 42 can identify movement trajectories of the other-device drones 101 to 103 particularly on the basis of the pieces of the position information of the other-device drones 101 to 103 and the pieces of the information of the time at which the other-device drones 101 to 103 have respectively sent out the unique information ID1 to ID3. Furthermore, the flight controller 42 can estimate the future positions of the other-device drones 101 to 103 on the basis of the identified movement trajectories.

Then, as described above, in a case where another moving object, such as the other-device drones 101 to 103, in proximity to the drone 10 is detected on the basis of such as the pieces of the position information of the other-device drones 101 to 103 detected from the pieces of the unique information ID1 to ID3, the flight controller 42 can control the driving of the drone 10 so as to move the drone 10 away from the other moving object. Specifically, the flight controller 42 can control the driving of the drone 10, for example, so as to move the drone 10 away from the other-device drones 101 to 103 on the basis of any of the relative positions (for example, X, Y, Z) of the other-device drones 101 to 103 with respect to the drone 10, the distances and directions of the other-device drones 101 to 103 with respect to the drone 10, the movement trajectories of the other-device drones 101 to 103, and the future positions of the other-device drones 101 to 103. Note that in the above description, it has been described that the flight controller 42 receives the pieces of the unique information ID1 to ID3 and performs various types of processing on the basis of the pieces of the unique information ID1 to ID3. However, it goes without saying that the flight controller 42 can receive the unique information from another moving object and perform similar processing.

In addition, the flight controller 42 records the position information of the drone 10 in the memory 80. The recording of the position information of the drone 10 may be periodically performed. In addition, the flight controller 42 records, in the memory 80, pieces of the unique information received from the other-device drones 101 to 103 and the like. The unique information may be recorded every time the unique information is received.

The communication module 50 communicates with external devices such as the operation device 20 and the other-device drones 101 to 103 through wireless communication, to transmit and receive information. The communication module 50 includes a first communication unit 51 and a second communication unit 52. The first communication unit 51 communicates with the operation device 20 that remotely controls the drone 10, to receive at least information for driving the drone 10. The information for controlling the driving of the drone 10 is, for example, the control command transmitted from the operation device 20 to the drone 10. In addition, the first communication unit 51 can transmit the position information of the drone 10 and the like to the operation device 20. In the present embodiment, the second communication unit 52 transmits the unique information of the own device and receives the unique information from another moving object, such as the other-device drones 101 to 103.

The wireless communication method of the first communication unit 51 and the second communication unit 52 may be any appropriate method. As an example, the communication method may be based on the IEEE 802.11 standard, the IEEE 802.15.1 standard (Bluetooth (registered trademark)), an OFDM modulation scheme, or other standards. The frequency band to be used for wireless communication is a 2.4 GHz band, a 5 GHz band, or other frequency bands, for example. In addition, the first communication unit 51 and the second communication unit 52 may be capable of transmitting and/or receiving information according to a plurality of wireless communication standards.

Note that the wireless communication method of the second communication unit 52 needs to be a method in which the flying object monitoring facility 110 and another device can receive the unique information of the own device and a method in which the own device can receive the unique information of the other device. In the present embodiment, the drone 10 transmits and receives information designated by the remote ID system. The information designated by the remote ID system is designated to be sent out according to, for example, the IEEE 802.11 standard or Bluetooth (registered trademark). Thus, in the present embodiment, the second communication unit 52 transmits, as the unique information, the information designated by the remote ID according to the IEEE 802.11 standard or Bluetooth (registered trademark). In addition, the second communication unit 52 receives, as the unique information, the information designated by the remote ID according to both the IEEE 802.11 standard and Bluetooth (registered trademark). In a case where the second communication unit 52 can receive the unique information according to two or more wireless communication methods (standards) and demodulate the unique information, it is possible to receive pieces of the unique information sent out from other moving objects without omission. This improves the reliability of detecting other devices.

The front camera 60 mainly images the front (moving direction) of the drone 10. The front camera 60 is provided mainly for acquiring images to be recorded or transferred to the operation device 20. As illustrated in FIG. 1, the front camera 60 is arranged below an airframe 11 of the drone 10 and is supported by the airframe 11.

The drive module 70 includes motors 71 and propellers 72 rotated by the motor 71. The drone 10 can ascend directly upward by uniformly rotating the plurality of propellers 72, and can perform movements with inclination such as moving forward, moving backward, turning left, and turning right by generating a rotation difference between the plurality of propellers 72. As illustrated in FIG. 1, the motors 71 and the propellers 72 are supported by the airframe 11 The flight controller 42 controls the rotational speed of each propeller 72 by controlling power supplied to each motor 71 with a driver (electric speed controller (ESC)) (not illustrated). Accordingly, the flight controller 42 operates the drone 10 in a desired state.

The memory 80 is, for example, a hard disk, an optical disk, a flash memory, or a magnetic tape, but is not limited thereto.

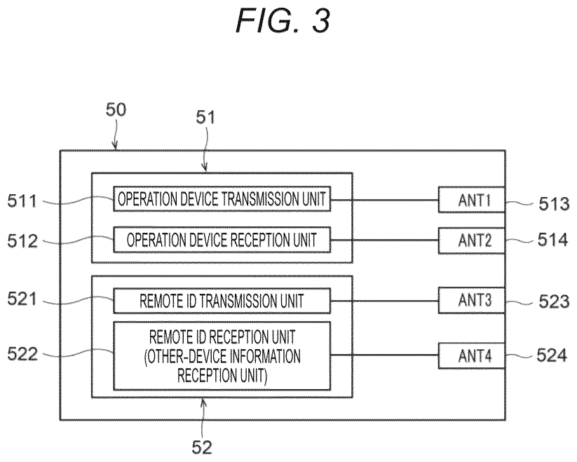

FIG. 3 is a block diagram illustrating a detailed configuration of the communication module 50. As illustrated in FIG. 3, in the communication module 50 in the present embodiment, the first communication unit 51 includes an operation device transmission unit 511, an operation device reception unit 512, a first antenna 513, and a second antenna 514. The second communication unit 52 includes a remote ID transmission unit 521, a remote ID reception unit 522, a third antenna 523, and a fourth antenna 524.

In the first communication unit 51, the operation device transmission unit 511 includes a modulation circuit and the like. Then, the operation device transmission unit 511 and the first antenna 513 are connected. The first antenna 513 functions as a transmission antenna. The operation device transmission unit 511 transmits, for example, the position information of the drone 10 and an image signal of an image captured by the drone 10 to the operation device 20. In addition, the operation device transmission unit 511 may further transmit at least one of the unique information received by the remote ID reception unit 522, the receipt of the unique information, and the position information of another moving object detected on the basis of the unique information to the operation device 20. Furthermore, the operation device reception unit 512 includes a demodulation circuit and the like. Then, the operation device reception unit 512 and the second antenna 514 are connected. The second antenna 514 functions as a reception antenna. The operation device reception unit 512 receives and demodulates the information of the control command from the operation device 20, to provide the information to the application processor 41, for example.

In the illustrated example, the operation device transmission unit 511 and the operation device reception unit 512 are provided on the same circuit board. However, the operation device transmission unit 511 and the operation device reception unit 512 may be provided on circuit boards different from each other.

In the second communication unit 52, the remote ID transmission unit 521 includes a modulation circuit and the like. Then, the remote ID transmission unit 521 and the third antenna 523 are connected. The third antenna 523 functions as a transmission antenna. In the example of FIG. 1, the remote ID transmission unit 521 sends out the unique information ID0 (in the present example, the information of the aircraft registration number, the information of the aircraft manufacturing number, the information of the current position, and the information of the current time) of the own device for the purpose of causing the flying object monitoring facility 110 to receive the information.

Furthermore, the remote ID reception unit 522 includes a demodulation circuit and the like. Then, the remote ID reception unit 522 and the fourth antenna 524 are connected. The fourth antenna 524 functions as a reception antenna. The remote ID reception unit 522 receives the unique information from another moving object such as the other-device drones 101 to 103. Then, the remote ID reception unit 522 demodulates the unique information received from the other moving object, to provide the unique information to the application processor 41. In the present embodiment, the remote ID reception unit 522 can demodulate both carrier waves (carriers) through the IEEE 802.11 standard and Bluetooth (registered trademark). The remote ID reception unit 522 corresponds to an other-device information reception unit.

In the illustrated example, the remote ID transmission unit 521 and the remote ID reception unit 522 are provided on circuit boards different from each other and physically separated from each other. In this case, for example, the remote ID transmission unit 521 and the remote ID reception unit 522 may be accommodated in housings different from each other, and may be detachably attached to desired positions in the airframe 11, at positions separated from each other. However, the remote ID transmission unit 521 and the remote ID reception unit 522 may be provided on the same circuit board. Note that the above description notes that the transmission unit/reception unit and the antenna are connected. This description specifically means that the transmission unit/reception unit and the antenna are connected by wire. The transmission unit/reception unit and the antenna may be connected via an RF coaxial cable.

### <Configuration of Other-Device Drone>

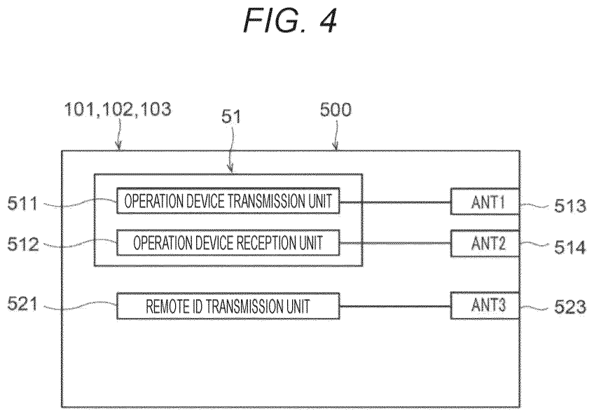

FIG. 4 is a block diagram illustrating an example of a configuration of the other-device drones 101 to 103 The other-device drones 101 to 103 each do not include the remote ID reception unit 522 that is included in the drone 10, and do not include a means of recording and analyzing the unique information and a means of using the unique information for its control. Other configurations of the other-device drones 101 to 103 are similar to those of the drone 10.

FIG. 4 illustrates a configuration of the other-device communication module 500 in the other-device drones 101 to 103. Similar to the communication module 50 of the drone 10, the other-device communication module 500 includes the first communication unit 51 including the operation device transmission unit 511, the operation device reception unit 512, the first antenna 513, and the second antenna 514. Meanwhile, the other-device communication module 500 includes the remote ID transmission unit 521 and the third antenna 523, but does not include the remote ID reception unit 522.

The other-device drones 101 to 103 each send out, from the remote ID transmission unit 521 and the third antenna 523, the unique information (in the present example, the information of the aircraft registration number, the information of the aircraft manufacturing number, the information of the current position, and the information of the current time) for the purpose of causing the flying object monitoring facility 110 to receive the information. On the other hand, in the drone 10 according to the embodiment, the remote ID reception unit 522 can receive the pieces of the unique information sent out from the other-device drones 101 to 103.

### <Control of Drone>

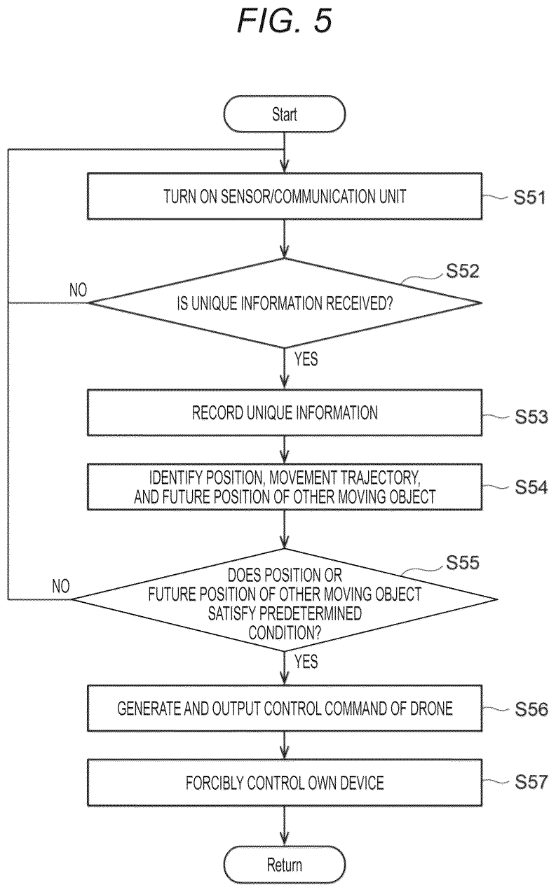

Next, an example of processing to be performed in the drone 10 will be described with reference to a flowchart illustrated in FIG. 5.

The processing illustrated in FIG. 5 starts upon turning on the drone 10. After starting the processing, first, the drone 10 starts sensing by the sensor module 30 and information reception processing by the communication module 50 (step S51).

Next, the drone 10 determines whether or not the unique information has been received from another moving object such as the other-device drones 101 to 103 (step S52).

In a case where the unique information has not been received, the processing returns to step S51, and the drone 10 repeats the information reception processing by the communication module 50. On the other hand, in a case where the unique information has been received, the drone 10 records the received unique information in the memory (step S53).

Next, the drone 10 identifies at least one of the relative position (for example, X, Y, Z), and the distance and direction of the other moving object such as the other-device drones 101 to 103 with respect to the drone 10 on the basis of the received unique information. In addition, the drone 10 identifies, on the basis of the received unique information, the movement trajectory of the other moving object such as the other-device drones 101 to 103 and the future position of the other moving object based on the movement trajectory (step S54).

Then, the drone 10 determines whether or not the position or the future position of the other moving object satisfies a predetermined condition (step S55). Specifically, for example, it may be determined whether or not the distance between the drone 10 and the position of the other moving object, or the distance between the drone 10 and the future position of the other moving object is equal to or less than a predetermined value. Then, in a case where the distance is equal to or less than the predetermined value, it may be determined that the other moving object is in proximity to the drone 10.

In a case where the position or the future position of the other moving object does not satisfy the predetermined condition in step S55, the processing returns to step S51. On the other hand, in a case where the position or the future position of the other moving object satisfies the predetermined condition in step S55, the drone 10 generates and outputs the control command related to movement of the drone 10 (step S56). The control command generated in this step may be a control command for increasing the distance to the other moving object determined to be in proximity. Alternatively, the control command may be a control command for limiting or discarding movement in the direction of approaching the other moving object determined to be in proximity.

Then, in a case where the control command is generated in step S56, the drone 10 is forcibly controlled according to the control command in step S56 (step S57). For example, in step S56, the drone 10 may be forcibly controlled so as to increase the distance to the other moving object determined to be in proximity. Alternatively, the drone 10 may be forcibly controlled so as to limit or discard movement in the direction of approaching the other moving object determined to be in proximity.

Then, after step S57, the processing returns to step S51. In the present embodiment, the processing illustrated in FIG. 5 continues until the power of the drone 10 is turned off. Note that specifically, the processing in steps S53 to S57 is performed by the flight controller 42.

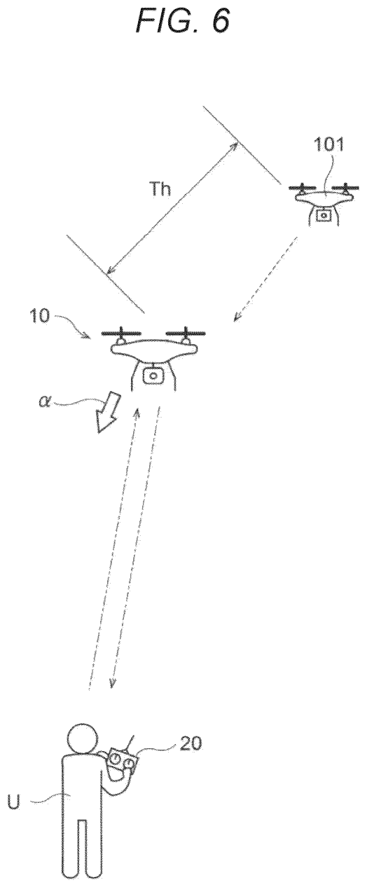

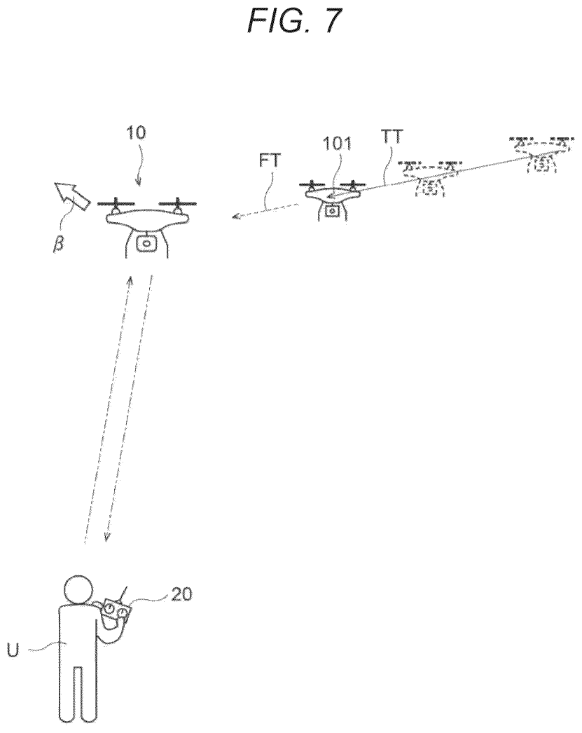

FIG. 6 and FIG. 7 are diagrams illustrating examples of operation of the drone 10 controlled with the processing illustrated in FIG. 5. FIG. 6 illustrates an example in which the distance between the drone 10 and the other-device drone 101 becomes equal to or less than the predetermined value, and the drone 10 is forcibly controlled so as to be away from the other-device drone 101. In FIG. 6, it is determined that the distance between the drone 10 and the other-device drone 101 is equal to or less than a predetermined value Th in step S55, and the drone 10 is controlled so as to be away from the other-device drone 101 in the direction of an arrow a in steps S56 and S57.

FIG. 7 illustrates an example in which the distance between the drone 10 and the future position of the other-device drone 101 becomes equal to or less than the predetermined value, and the drone 10 is forcibly controlled so as to be away from the other-device drone 101. In FIG. 7, a solid line arrow TT indicates the movement trajectory identified in step S54, and a broken arrow FT indicates the future position identified in step S54. Then, it is determined that the distance between the drone 10 and the future position FT is equal to or less than a predetermined value, and the drone 10 is controlled so as to be away from the other-device drone 101 in the direction of an arrow B in steps S56 and S57.

The drone 10 according to the present embodiment described above includes the flight controller 42 corresponding to the drive control unit that controls the driving of the drone 10, the first communication unit 51 corresponding to the communication unit that communicates with the operation device 20 that remotely controls the drone 10, and the remote ID reception unit 522 corresponding to the other-device information reception unit that receives unique information sent out from another moving object for identifying presence and/or a position of the other moving object. This configuration makes it possible to detect another moving object with high reliability.

That is, the drone 10 wirelessly receives the unique information for identifying the presence and/or the position of another moving object with the remote ID reception unit 522. In this case, the phenomenon of the infrared light passing through an object to be detected that may occur when using the TOF or the phenomenon of an object to be detected moving out of the angle of view that may occur when using the camera does not occur, so that the unique information for identifying the presence and/or the position of another moving object can be reliably received from all directions from the other moving object that is the object to be detected. Furthermore, even when the drone 10 and another moving object are relatively separated from each other, the unique information can be received. In particular, in the present embodiment, the unique information is the information designated by the remote ID system and is transmitted according to a predetermined standard such as the IEEE 802.11 standard and Bluetooth (registered trademark). Thus, when the distance between the drone 10 and the other moving object is, for example, several hundred meters, the unique information from the other moving object can be reliably received. Furthermore, the drone 10 can receive information from another moving object in midair, so that a situation where the unique information fails to be received due to an obstacle is also suppressed. Thus, it is possible to detect another moving object with high reliability on the basis of the unique information and by collecting the unique information reliably.

In addition, when receiving the unique information, the drone 10 can further transmit at least one of the unique information received by the remote ID reception unit 522, the receipt of the unique information, and the position information of another moving object detected on the basis of the unique information to the operation device 20. In this case, for example, the operator U can operate the drone 10 while considering the other moving object on the basis of the information received with the operation device 20, and the safety of the flight of the drone 10 can be enhanced. Furthermore, the unique information may be utilized for improving the accuracy of position accuracy information by correcting the position accuracy information of the drone 10 on the basis of the received unique information sent out from the other moving object.

Furthermore, in the present embodiment, the unique information received by the remote ID reception unit 522 includes at least the aircraft registration number of the other moving object and the position information of the other moving object. In this case, the presence of the other moving object and the other position information can be easily identified through demodulation of the unique information by the analysis unit 42A. Furthermore, by considering the position information of the drone 10, the relative position of the other moving object with respect to the drone 10 and the distance and direction of the other moving object with respect to the drone 10 can be easily identified. In addition, the unique information received by the remote ID reception unit 522 further includes the information of the time at which the other moving object has sent out the unique information. In this case, for example, the movement trajectory of the other moving object can be easily identified. Furthermore, the future position of the other moving object can be easily identified on the basis of the identified movement trajectory.

In addition, in the present embodiment, the flight controller 42 controls the driving of the drone 10 on the basis of the unique information. In this case, the drone 10 may move so as to avoid another moving object autonomously, for example. Accordingly, the safety of the flight of the drone 10 can be effectively enhanced.

Specifically, in the present embodiment, the flight controller 42 controls the driving of the drone 10 on the basis of the position information of another moving object. Furthermore, the flight controller 42 controls the driving of the drone 10 on the basis of the future position of the other moving object. Accordingly, the safety of the flight of the drone 10 can be effectively enhanced.

In addition, the drone 10 further includes the memory 80 corresponding to a recording unit that records the received unique information. This makes it possible to, for example, precisely analyze the flight state of another moving object afterwards.

The drone 10 further includes the sensor module 30 corresponding to the detection unit that detects an obstacle present around the drone 10. Specifically, the drone 10 detects an obstacle present around itself with the stereo camera 31 and the TOF sensor 33. In this case, the drone 10 can detect another moving object with higher reliability through cooperation of the sensor module 30 and the detection of another moving object based on the unique information received with the remote ID reception unit 522. Specifically, another moving object at a distance is detected by the detection of another moving object based on the unique information received with the remote ID reception unit 522, and another moving object at a short distance is detected by the sensor module 30, so that the reliability of detecting another moving object can be effectively improved.

Furthermore, by simplifying the sensor module 30 due to the detection of another moving object based on the unique information received with the remote ID reception unit 522, it is possible to simplify the device and suppress its weight while securing desired object detection performance.

Furthermore, in the present embodiment, the drone 10 may analyze the received unique information, to identify the period in which the unique information is sent out. Here, the first communication unit 51 may change the timing of transmitting and receiving information according to the identified period. In this case, the communication state between the drone 10 and the operation device 20 can be adjusted to a favorable state.

Hereinafter, modifications will be described. In each modification described below, the same reference signs are assigned to the same components as those in the above-described embodiment.

### <Modification 1>

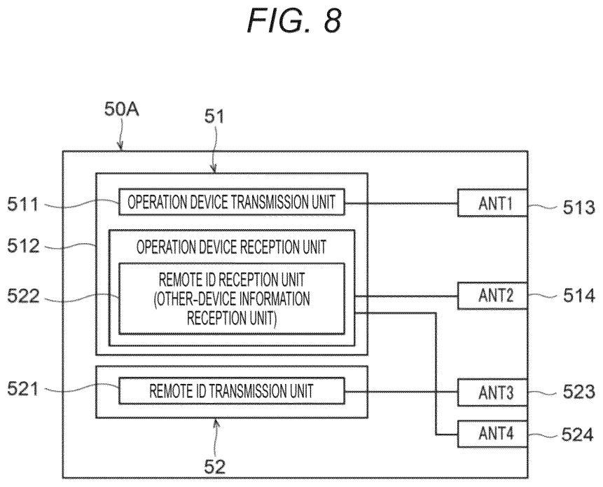

FIG. 8 illustrates a configuration of a communication module 50A according to a modification 1. The modification 1 is different from the above-described embodiment in that the remote ID reception unit 522 is provided in the first communication unit 51.

In the modification 1, the remote ID reception unit 522 is incorporated in the operation device reception unit 512 in the first communication unit 51, and the remote ID reception unit 522 shares, with the operation device reception unit 512, the demodulation circuit provided in the operation device reception unit 512. Meanwhile, the operation device reception unit 512 is connected to the second antenna 514. The remote ID reception unit 522 is connected to the fourth antenna 524. The remote ID reception unit 522 retrieves information received from the fourth antenna 524 and demodulated by the demodulation circuit in the operation device reception unit 512, to provide the information to the application processor 41.

In the present example, the demodulation circuit shared by the operation device reception unit 512 and the remote ID reception unit 522 can demodulate signals modulated according to both the IEEE 802.11 standard and Bluetooth (registered trademark). Accordingly, the unique information transmitted according to the IEEE 802.11 standard and the unique information transmitted according to Bluetooth (registered trademark) can be received and demodulated. Note that the operation device reception unit 512 and the remote ID reception unit 522 may share an antenna.

The modification 1 described above is advantageous in terms of simplification and compactness of the communication module 50A.

### <Modification 2>

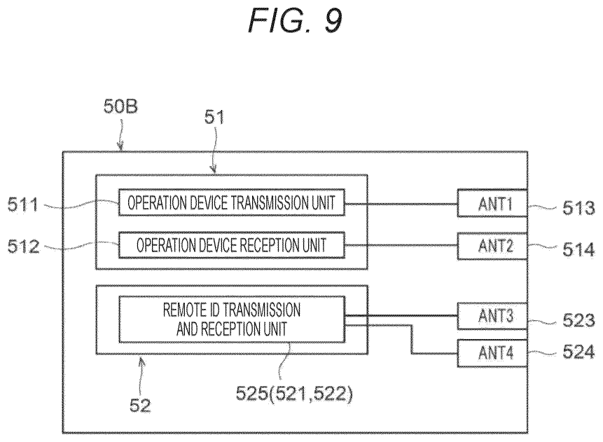

FIG. 9 illustrates a configuration of a communication module 50B according to a modification 2. The modification 2 is different from the above-described embodiment in that the second communication unit 52 includes a remote ID transmission and reception unit 525 in which the remote ID transmission unit 521 and the remote ID reception unit 522 are integrated. The remote ID transmission and reception unit 525 is connected to the third antenna 523 and the fourth antenna 524.

Specifically, the remote ID transmission and reception unit 525 transmits, as the unique information, the information designated by the remote ID system according to the IEEE 802.11 standard or Bluetooth (registered trademark) with the corresponding portion to the remote ID transmission unit 521. The remote ID transmission and reception unit 525 receives, as the unique information, the information designated by the remote ID system according to both the IEEE 802.11 standard or Bluetooth (registered trademark) with the corresponding portion to the remote ID reception unit 522.

As an aspect of integration of the remote ID transmission unit 521 and the remote ID reception unit 522, a configuration may be adopted in which, for example, the remote ID transmission unit 521 and the remote ID reception unit 522 are provided on the same circuit board. In addition, as an aspect of integration of the remote ID transmission unit 521 and the remote ID reception unit 522, a configuration may be adopted in which the remote ID transmission unit 521 and the remote ID reception unit 522 are provided on circuit boards different from each other and accommodated in a common housing.

The modification 2 described above is also advantageous in terms of simplification and compactness of the communication module 50B.

### <Modification 3>

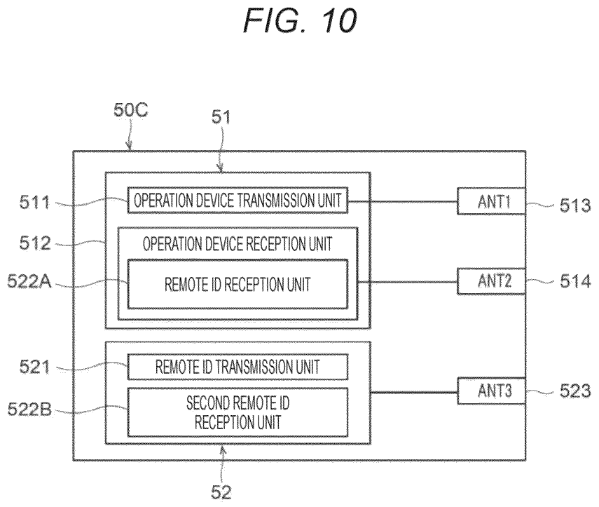

FIG. 10 illustrates a configuration of a communication module 50C according to a modification 3. The modification 3 is different from the above-described embodiment in that the first communication unit 51 is provided with a first remote ID reception unit 522A and the second communication unit 52 is provided with a second remote ID reception unit 522B.

In the first communication unit 51, the operation device transmission unit 511 includes the modulation circuit that performs modulation according to a first communication method. Then, the operation device reception unit 512 includes the demodulation circuit that performs demodulation according to the first communication method. The first remote ID reception unit 522A shares, with the operation device reception unit 512, the demodulation circuit provided in the operation device reception unit 512. Then, the operation device reception unit 512 and the first remote ID reception unit 522A share the second antenna 514. The first remote ID reception unit 522A retrieves information received from the second antenna 514 and demodulated by the demodulation circuit in the operation device reception unit 512, to provide the information to the application processor 41.

In the second communication unit 52, the remote ID transmission unit 521 and the second remote ID reception unit 522B are integrated. The remote ID transmission unit 521 includes the modulation circuit that performs modulation according to a second communication method different from the first communication method. Then, the second remote ID reception unit 522B includes the demodulation circuit that performs demodulation according to the second communication method. Then, the remote ID transmission unit 521 and the second remote ID reception unit 522B share the third antenna 523.

That is, the first communication unit 51 can receive the unique information transmitted from another moving object according to the first communication method, and the second communication unit 52 can receive the unique information transmitted from another moving object according to the second communication method. Here, for example, the first communication method may be one of the EEE 802.11 standard and Bluetooth (registered trademark), and the second communication method may be the other of the IEEE 802.11 standard and Bluetooth (registered trademark).

The modification 3 described above is also advantageous in terms of simplification and compactness of the communication module 50C.

### <Modification 4>

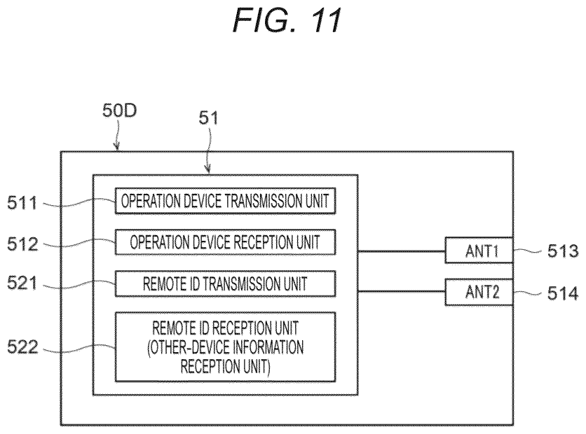

FIG. 11 illustrates a configuration of a communication module 50D according to a modification 4. The modification 4 is different from the above-described embodiment in that the first communication unit 51 is provided with the remote ID transmission unit 521 and the remote ID reception unit 522.

In the first communication unit 51, the operation device transmission unit 511 includes the modulation circuit that performs modulation according to the first communication method and the second communication method different from the first communication method. The operation device reception unit 512 includes the demodulation circuit that performs demodulation according to the first communication method and the second communication method. Then, the remote ID transmission unit 521 shares the modulation circuit provided in the operation device transmission unit 511. Furthermore, the remote ID transmission unit 521 shares the first antenna 513 with the operation device transmission unit 511. Then, the remote ID transmission unit 521 transmits, from the first antenna 513, the unique information modulated using the modulation circuit provided in the operation device transmission unit 511.

Meanwhile, the remote ID reception unit 522 shares the demodulation circuit provided in the operation device reception unit 512. Furthermore, the remote ID reception unit 522 shares the second antenna 514 with the operation device reception unit 512. Then, the remote ID reception unit 522 provides, to the application processor 41, the unique information from another moving object demodulated using the demodulation circuit provided in the operation device reception unit 512.

The modification 4 described above is very advantageous in terms of simplification and compactness of the communication module 50D.

### <Hardware Configuration>

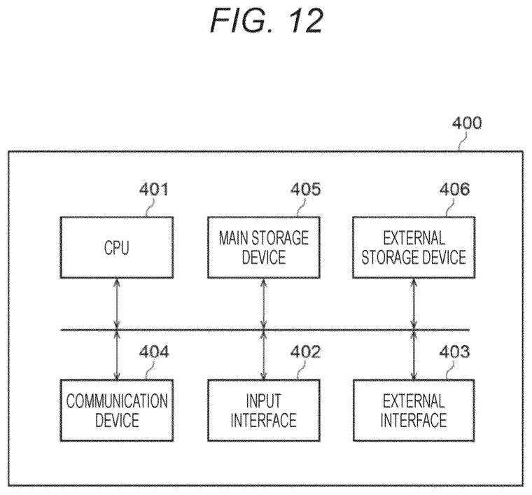

FIG. 12 illustrates an example of a hardware configuration of the drone 10. A part of the drone 10 is constituted by a computer device 400. The computer device 400 includes a CPU 401, an input interface 402, an external interface 403, a communication device 404, a main storage device 405, and an external storage device 406, which are interconnected to each other via a bus. At least one of these components may not be included in the drone 10.

The central processing unit (CPU) 401 executes a computer program on the main storage device 405. The computer program is a program that implements each of the above-described functional configurations of the drone 10. The computer program may be implemented by a combination of a plurality of programs and scripts, instead of one program. The CPU 401 executes the computer program, to implement each of the functional components.

The input interface 402 is a circuit for inputting, to the drone 10, an operation signal from an input device such as a keyboard, a mouse, and a touch panel.

The external interface 403 displays, on a display device, data stored in the drone 10 or data calculated by the drone 10, for example. The external interface 403 may be connected to a liquid crystal display (LCD), an organic electroluminescence display, a cathode ray tube (CRT), or a plasma display (PDP), for example.

The communication device 404 is a circuit for the drone 10 to communicate with an external device by wire or wirelessly. The communication device 404 is a portion corresponding to the communication module 50 and the like. Data used in the drone 10 can be input from the external device via the communication device 404. The communication device 404 includes an antenna. Data input from the external device can be stored in the main storage device 405 or the external storage device 406.

The main storage device 405 stores a computer program, data necessary for executing the computer program, data generated as a result of execution of the computer program, and the like. The computer program is deployed and executed on the main storage device 405. The main storage device 405 is, for example, a RAM, a DRAM, or an SRAM, but is not limited thereto. A storage unit for information and data in the communication device 404 may be constructed on the main storage device 405.

The external storage device 406 stores a computer program, data necessary for executing the computer program, data generated as a result of execution of the computer program, and the like. The computer program and the data are read into the main storage device 405 when the computer program is executed. The external storage device 406 is, for example, a hard disk, an optical disk, a flash memory, and a magnetic tape, but is not limited thereto.

Note that the computer program may be installed in the computer device 400 in advance or may be stored in a storage medium such as a CD-ROM. Alternatively, the computer program may be uploaded on the Internet.

Furthermore, the computer device 400 may be configured as a single device, or may be configured as a system including a plurality of computer devices connected to each other.

Note that the embodiment described above illustrates an example for embodying the present disclosure, and the present disclosure can be implemented in various other forms. For example, various modifications, replacements, omissions, or combinations thereof can be made without departing from the gist of the present disclosure. Forms in which such modifications, replacements, omissions, and the like have been made are also included in the scope of the present disclosure and are likewise included in the invention described in the claims and the equivalent scopes thereof.

For example, in the above-described embodiment, an example of a drone that is an unmanned flying object has been described as an example of the unmanned moving object. However, the technique of the present disclosure can also be applied to an underwater drone, and the like.

Furthermore, the effects of the present disclosure described in the present specification are merely an example, and other effects may be exerted.

Note that the present disclosure can also have the following configurations.

### [Item 1]

An unmanned moving object including
a drive control unit that controls driving of the unmanned moving object,
a communication unit that communicates with an operation device that remotely controls the unmanned moving object, and
an other-device information reception unit that receives unique information sent out from another moving object for identifying presence and/or a position of the another moving object.

### [Item 2]

The unmanned moving object according to item 1, further including a detection unit that detects an obstacle present around the unmanned moving object.

### [Item 3]

The unmanned moving object according to item 2, in which the detection unit includes any one of, or a combination of two or more of a camera, an optical ranging sensor, a millimeter-wave ranging sensor, and an ultrasonic ranging sensor.

### [Item 4]

The unmanned moving object according to any one of items 1 to 3, in which the drive control unit controls the driving of the unmanned moving object on the basis of the unique information.

### [Item 5]

The unmanned moving object according to any one of items 1 to 4, further including a recording unit that records the unique information.

### [Item 6]

The unmanned moving object according to any one of items 1 to 5, in which the unique information includes at least an aircraft registration number of the another moving object and position information of the another moving object.

### [Item 7]

The unmanned moving object according to item 6, in which the unique information further includes information of time at which the another moving object has sent out the unique information.

### [Item 8]

The unmanned moving object according to item 6 or 7, in which the drive control unit identifies at least one of a relative position, and a distance and direction of the another moving object with respect to the unmanned moving object on the basis of position information of the unmanned moving object, the aircraft registration number of the another moving object, and the position information of the another moving object.

### [Item 9]

The unmanned moving object according to item 7 or 8, in which the drive control unit identifies a movement trajectory of the another moving object on the basis of the aircraft registration number of the another moving object, the position information of the another moving object, and the information of the time at which the another moving object has sent out the unique information.

### [Item 10]

The unmanned moving object according to any one of items 1 to 9, in which the drive control unit controls the driving of the unmanned moving object on the basis of the position information of the another moving object.

### [Item 11]

The unmanned moving object according to item 9, in which the drive control unit identifies a future position of the another moving object on the basis of the movement trajectory.

### [Item 12]

The unmanned moving object according to item 11, in which the drive control unit controls the driving of the unmanned moving object on the basis of the future position of the another moving object.

### [Item 13]

The unmanned moving object according to any one of items 1 to 12, in which the communication unit and the other-device information reception unit are integrated.

### [Item 14]

The unmanned moving object according to any one of items 1 to 13, further including an analysis unit that analyzes the unique information and identifies whether or not the unique information has been sent out from the another moving object and/or position information of the another moving object.

### [Item 15]

The unmanned moving object according to item 14, in which the analysis unit further identifies a period in which the unique information is sent out.

### [Item 16]

The unmanned moving object according to item 15, in which the communication unit changes timing of transmitting and receiving information on the basis of the period identified by the analysis unit.

### [Item 17]

The unmanned moving object according to any one of items 1 to 16, in which the unique information includes information that is mandated by a country or a local government to be sent out when moving a moving object.

### [Item 18]

The unmanned moving object according to any one of items 1 to 17, in which the unique information includes information designated by a remote ID system mandated by a country (Japan, the United States of America, the European Union, and the like) regarding flight of an unmanned flying object.

### [Item 19]

An information processing method performed in an unmanned moving object, the information processing method including
a step of receiving unique information sent out from another moving object for identifying presence and/or a position of the another moving object.

### [Item 20]

A computer program for executing information processing in an unmanned moving object, the computer program for
causing a computer to execute a step of receiving unique information sent out from another moving object for identifying presence and/or a position of the another moving object.

### REFERENCE SIGNS LIST

10 Drone (Unmanned moving object)
11 Airframe
20 Operation device
30 Sensor module
31 Stereo camera
32 IMU
33 TOF sensor
34 Geomagnetic sensor
35 Barometric pressure sensor
36 GNSS reception unit
40 Sensing processor
41 Application processor
42 Flight controller
42A Analysis unit
50, 50A, 50B, 50C, 50D Communication module
500 Other-device communication module
51 First communication unit
511 Operation device transmission unit
512 Operation device reception unit
513 First antenna
514 Second antenna
52 Second communication unit
521 Remote ID transmission unit
522 Remote ID reception unit
522A First remote ID reception unit
522B Second remote ID reception unit
523 Third antenna
524 Fourth antenna
525 Remote ID transmission and reception unit
60 Front camera
70 Drive module
71 Motor
72 Propeller
80 Memory
101, 102, 103 other-device drone (another moving object)
110 Flying object monitoring facility
112 Antenna
400 Computer device
401 CPU
402 Input interface
403 External interface
404 Communication device
405 Main storage device
406 External storage device

1. An unmanned moving object comprising:
a drive control unit that controls driving of the unmanned moving object;
a communication unit that communicates with an operation device that remotely controls the unmanned moving object; and
an other-device information reception unit that receives unique information sent out from another moving object for identifying presence and/or a position of the another moving object.

2. The unmanned moving object according to claim 1, further comprising: a detection unit that detects an obstacle present around the unmanned moving object.

3. The unmanned moving object according to claim 2, wherein the detection unit includes any one of, or a combination of two or more of a camera, an optical ranging sensor, a millimeter-wave ranging sensor, and an ultrasonic ranging sensor.

4. The unmanned moving object according to claim 1, wherein the drive control unit controls the driving of the unmanned moving object on a basis of the unique information.

5. The unmanned moving object according to claim 1, further comprising: a recording unit that records the unique information.

6. The unmanned moving object according to claim 1, wherein the unique information includes at least an aircraft registration number of the another moving object and position information of the another moving object.

7. The unmanned moving object according to claim 6, wherein the unique information further includes information of time at which the another moving object has sent out the unique information.

8. The unmanned moving object according to claim 6, wherein the drive control unit identifies at least one of a relative position, and a distance and direction of the another moving object with respect to the unmanned moving object on a basis of position information of the unmanned moving object, the aircraft registration number of the another moving object, and the position information of the another moving object.

9. The unmanned moving object according to claim 7, wherein, the drive control unit identifies a movement trajectory of the another moving object on a basis of the aircraft registration number of the another moving object, the position information of the another moving object, and the information of the time at which the another moving object has sent out the unique information.

10. The unmanned moving object according to claim 6, wherein the drive control unit controls the driving of the unmanned moving object on a basis of the position information of the another moving object.

11. The unmanned moving object according to claim 9, wherein the drive control unit identifies a future position of the another moving object on a basis of the movement trajectory.

12. The unmanned moving object according to claim 11, wherein the drive control unit controls the driving of the unmanned moving object on a basis of the future position of the another moving object.

13. The unmanned moving object according to claim 1, wherein the communication unit and the other-device information reception unit are integrated.

14. The unmanned moving object according to claim 1 further comprising: an analysis unit that analyzes the unique information and identifies whether or not the unique information has been sent out from the another moving object and/or the position information of the another moving object.

15. The unmanned moving object according to claim 14, wherein the analysis unit further identifies a period in which the unique information is sent out.

16. The unmanned moving object according to claim 15, wherein the communication unit changes timing of transmitting and receiving information on a basis of the period identified by the analysis unit.

17. The unmanned moving object according to claim 1, wherein the unique information includes information that is mandated by a country or a local government to be sent out when moving a moving object.

18. The unmanned moving object according to claim 17, wherein the unique information includes information designated by a remote ID system mandated by a country regarding flight of an unmanned flying object.

19. An information processing method performed in an unmanned moving object, the information processing method comprising:
a step of receiving unique information sent out from another moving object for identifying presence and/or a position of the another moving object.

20. A computer program for executing information processing in an unmanned moving object, the computer program for
causing a computer to execute: a step of receiving unique information sent out from another moving object for identifying presence and/or a position of the another moving object.
